(19) United States
(12) Patent Application Publication
(10) Pub. No.: US 2006/0129594 A1
(43) Pub. Date: Jun. 15, 2006

(54) Computer-implemented method for management of electronic data

(76) Inventors: Stephan Ernst, Wurenlos (CH); Markus Schumann, Wallisellen (CH)

Correspondence Address: PILLSBURY WINTHROP SHAW PITTMAN LLP, 1650 TYSONS BOULEVARD, MCLEAN, VA, 22102, US

(21) Appl. No.: 11/262,912

(22) Filed: Nov. 1, 2005

(30) Foreign Application Priority Data
Dec. 13, 2004 (EP) 04 029 462.1

(51) Int. Cl. G06F 17/00

(52) U.S. Cl. 707/102

(57) ABSTRACT

A computer-implemented method for management of electronic data, comprises the steps: Writing of a data record into a first database (50), checking of the unchanged contents of this one data record on at least one predetermined condition and writing of the one data record into a second database (52) dependent on the fulfilling of the at least one predetermined condition.

In many organizations, and also in public bodies, massive volumes of data accumulate nowadays, which have to be structured and systematically stored so that at a later time the background and details of the processes involved in the data flow can be traced, and evaluations can be made using the stored data. Banks are one example. In banking, an increasing differentiation in the offered services and prices has emerged in recent years and even decades. Earlier standard services (current account, securities account) with few variants are being replaced by an ever greater number of different services and price alternatives. The range of financial instruments on offer becomes continually wider, and the individual financial instruments more creative and sophisticated.

At the same time, customers' demands on banks are also growing, in terms of transparency, consistency and completeness of the information supplied to the customer by the bank. Many customers are no longer satisfied with simple statements on the current balance of their account. Discriminating and wealthy customers especially, who make use of a number of different services of a bank, for example because they carry out transactions in securities, property and other investments through the bank, demand complete and detailed information about any business case, and quickly. For automated preparation of a financial statement for a customer, detailed information is then necessary about all transactions relating to the customer's assets, whether cash transactions, securities business or similar.

Considering that banks handle many thousands of transactions daily, even hundreds of thousands, it is easy to see how large are the volumes of data to be coped with and saved in modern banking systems. Naturally, this is true not only for banks but also for numerous other organizations of an entrepreneurial or administrative nature.

For systematic and ordered storage of data, databases are used. In general a single database is used if possible for data of related content, this database being made big enough to take the total expected dataset. However, the bigger a database is, the more complex and time-consuming are the database accesses by application programs wanting to access the available data in the database. At the same time, the updating of the database by the entry of new data similarly takes time, and calls for complex measures so that the database remains available as usual to the application programs for read access during write operations.

It is therefore often accepted that not all desired data can be archived, and the action is restricted to certain data that is seen as absolutely essential. However, this necessarily reduces the depth of detail of the stored information.

It is the object of the invention to be able to save information in database form without restricting the depth of detail while the data is simultaneously highly available for application programs.

To achieve this object according to the invention, a computer-implemented method for management of electronic data is provided, which includes the following steps:

Writing of one data record into a first database,

Checking of the unchanged contents of this one data record on at least one predetermined condition and

Writing of the one data record into a second database depending on fulfilment of the at least one predetermined condition.

The solution according to the invention causes a “cleaning” of a first database, in that data records stored in it are copied to another, second database, but not dependent on a certain occupancy level of the first database, but rather dependent on whether the contents of the relevant data record meet one or more predetermined conditions. In this way the data volume stored in the first database can be kept relatively small. But since data records are always initially written to the first database before they are transferred at a later time to the second database, rapid write operations and also rapid read operations are possible in the first database.

This concept according to the invention allows the first database to be effectively used as a “variable” database, and the second database as a “static” database. In banks and other organisations there is frequently ongoing new (fresh) data that should be stored in a database. According to the invention, the first database can be used for the initial acceptance of such new data. It then forms a “current” database, whose content continually changes over a particular observed period, for example a working day. By suitable specification of the predetermined condition(s), two effects can now be achieved: Firstly, it can be achieved that the data volume held in the first database is significantly smaller than the data volume in the second database. Secondly, it can be achieved that write operations on the second database do not occur continually, as with the first database, but at greater time intervals, so that the second database remains unchanged during the aforementioned particular period, and can accordingly be seen as static. A static database of this kind is technically easier to set up and also easier to operate than a continually changing database. Write operations to the second database can be restricted to certain timeframes, for example, such as during the night or at weekends only.

The second database will subsequently be referred to as the historical database. This is certainly not suggesting that only such data as is old from the point of view of an application program should be stored in the second database. The immediacy of the data can be high in both databases from the point of view of the application programs. For a complete evaluation, it can easily be possible that an application program has to have access to data from both databases. However, it can be sensible for reasons of business security always to hold in the first database the “critical survival” data needed for the transactions of the bank or similar organization. For example, this critical survival data could include information on customer balances and recently effected transactions. The term “historical” accordingly refers only to the fact that the second database comes after the first database in the history of memory locations of the various data.

Since the second database can be set up as a static database, it can easily be sized so that it can accept very large data volumes. As the second database is then available as a reservoir for a large dataset, a high level of detail can be implemented with the solution according to the invention for the information being stored. For example, data records can be created and saved for each of the various intermediate phases of an investment—or a business case in general—to represent the status of the business case at the various phases.

It has emerged that the first database can be very much smaller that the second database. For example, the size of the first database can be less than 10%, and especially less that 5%, of the size of the second database.

In the method according to the invention, data records in the first database are preferably deleted at a time closely related to when they are written to the second database. In particular, the reading (for the purpose of transfer to the second database) and deletion of a data record in the first database can take place in a joint operation. Of course, it is not out of the question to retain a data record in the first database for a certain time after it was written to the second database.

In many cases, several data records that were simultaneously or successively saved in the first database can be logically linked together, for example because they relate to a common underlying business case. At data level, such a logical link can be evidenced by a common data element, which is included in each of the interrelated data records, and uniquely identifies the subject to which the data records refer, i.e. for example the underlying business case. According to a preferred development of the invention, depending on the writing of one data record to the second database, several other data records which are logically linked to this one data record can likewise be written to the second database. In this case too, each of the other data records in the first database is preferably deleted at a time closely related to when it is written to the second database.

In a preferred embodiment, at least some of the data records stored in the first database contain a status field, in which a status is entered. This status relates preferably not to the data record itself, but to the subject represented by the data record. For example, the status can relate to the current state of a single transaction or an entire business case, which possibly includes several such individual transactions. The validation step can include the checking of such a status field in the data records for a predetermined status.

Likewise according to a preferred embodiment of the invention, at least some of the data records stored in the first database can contain a time entry. Alternatively or in addition to the above status checking, the validation step can include checking of whether the time entry in a data record satisfies a predetermined condition.

It can happen that data records already copied to the second database, or rather their contents, later prove to be incorrect or invalid. It is now possible to change this with a write access to the data record concerned. However, such write accesses to databases with the purpose of changing an existing data record are relatively complex. In a preferred embodiment, the incorrect or invalid data record in the second database is therefore—at least temporarily—left there unchanged, and instead an indicator is recorded in the first database that the relevant data record in the second database is invalid. For this, a data record identifier uniquely identifying the relevant data record is written to the first database, and in addition an invalidity indicator relating to the data record identifier and marking the data record as invalid is written to the first database. It is feasible especially to set up in the first database a special table, in which only invalid data records of the second database are recorded.

At least some of the data records to be written to the first database can contain a time-stamp field with a time stamp. This time stamp can usefully be used to distinguish data records from one another, which actually represent one and the same information object, but describe different versions of this information object. Situations can be imagined in which an information object represented in a data system can go through different phases or states during its existence. For example, if a business order is seen as such an information object, various phases in the life of the order can easily be identified. For example, a phase can be defined in which the business order is placed but not yet accepted. Then a phase can be defined in which the business order is accepted, but its processing has not yet been started. A further phase can be defined in which the business order is fully executed. Further or other phases can naturally also be defined.

For the greatest possible level of detail of the stored information about the business case, it would be desirable to store data for each or at least some of the different phases through which the business case goes. With the help of the time stamp, versions of the same information object can be represented in a data system by generating a data record for each version with the same data record identifier each time, but entering a different time stamp each time in the time-stamp field of the data records of this information object. More details about the particular version can then be entered in one or more additional data record fields, one of which can be the previously mentioned status field. An entry can be made in this status field to show, for example, which phase or what status a business order—or in general the relevant information object—is in. This version creation for data records by means of time stamps is advantageous in that no complex changes need be made to existing data records in order to be able to represent changes to the underlying information object. The time stamp advantageously contains a date and a time.

It can accordingly happen that in the first database several data records related to one and the same information object are present, each representing a different version of this information object and having been written to the first database at different times, and consequently containing a different time stamp. A preferred embodiment then provides that if the one of these data records, whose time stamp identifies the youngest version of the information object, fulfils the at least one predetermined condition, each of these data records is written to the second database. In other words, with this embodiment all older versions of a data record or information object are automatically written to the second database, if the youngest version fulfils the predetermined condition(s).

Depending on the information model that was the basis for the life circumstances represented in data records, it can happen that the first database includes data records representing different information objects that are nonetheless logically linked together. Thus for example a data record can represent a business case generally, and one or more other data records can each represent a single transaction that took place within the business case. These transaction data records will contain a data element, which is also included in the business case data record and uniquely identifies the business case. In this way, the business case data record and the transaction data records are logically linked to each other.

It can then be advantageous if, when the at least one predetermined condition is met by one of the logically interlinked data records, the others of these data records are also copied from the first database to the second database. In particular, if the information objects are hierarchically linked to one another, the writing of a group of such hierarchically linked data records from the first to the second database can be made dependent on a data record, which represents an information object of a highest hierarchy level, fulfilling the at least one predetermined condition.

The invention further relates to a computer program product, which causes the execution of the method of the kind described above, when it is processed by a computer. The computer program product can be stored on a computer-readable magnetic or optical information carrier (such as a CD-ROM or a minidisk).

The invention will be further described on the basis of the included drawings. Shown are:

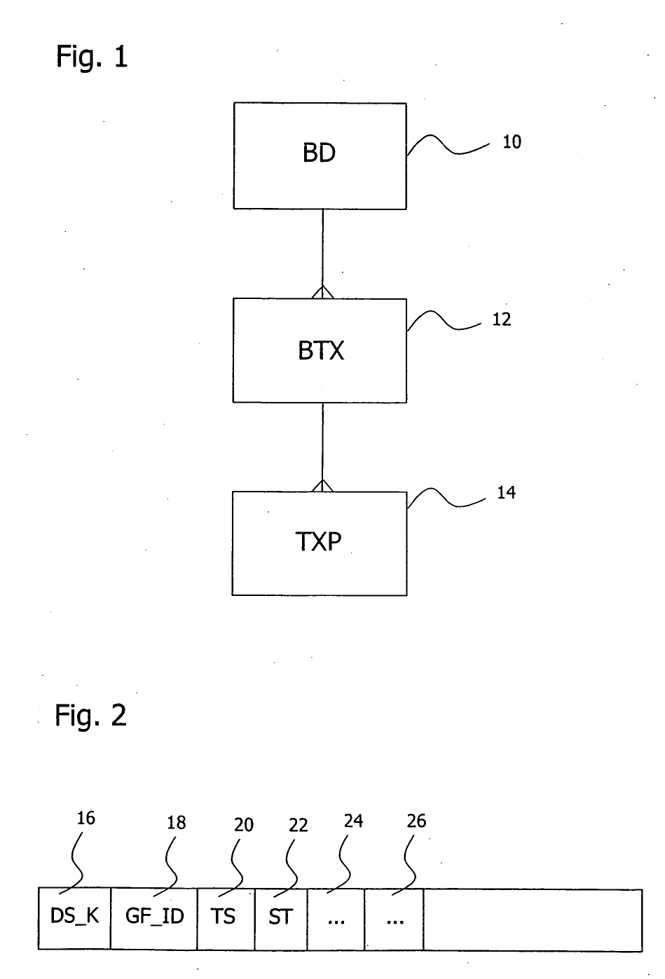

FIG. 1 a model shown as an example of the representation of business cases in a data system,

FIG. 2 an example of a data record format,

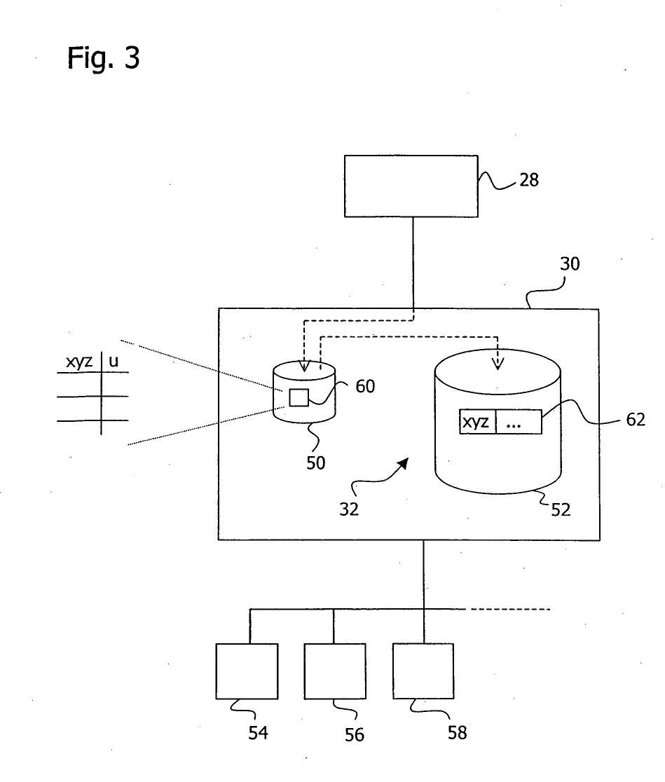

FIG. 3 a schematic example of architecture for performing the method according to the invention and

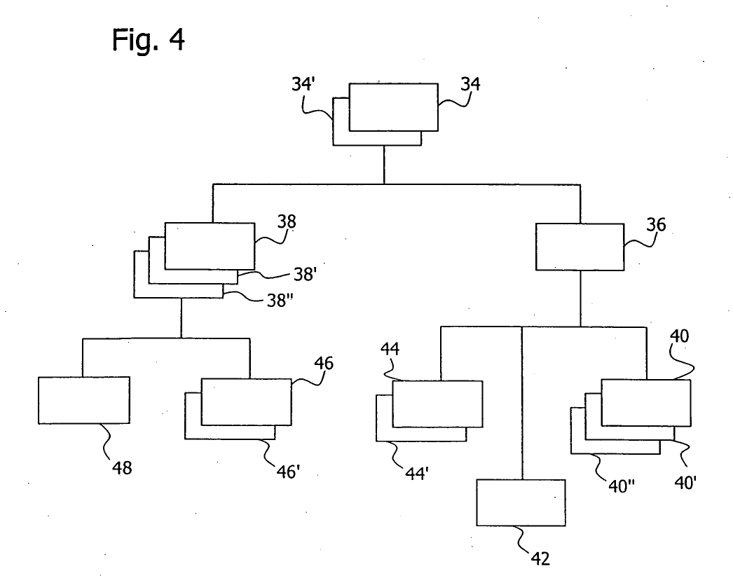

FIG. 4 an example of a data tree for a business case.

FIG. 1 shows various information objects 10, 12, 14 of a hierarchical information model, according to which, in an embodiment of the invention, subjects are represented in a data system. To represent a subject, the information objects are effectively put together like Lego bricks to form a complete picture. According to the information model, one or more information objects 12 can be assigned to an information object 10, and one or more information objects 14 can be assigned in turn to each information object 12. The information object 10 is thus the highest in the hierarchy, while information objects 12 are in the middle of the hierarchy and information objects 14 are at the bottom of the hierarchy.

It has emerged that such an information model is especially well suited to modelling services of a bank in a data system. The information object 10 can be used to describe the overall service agreed with a customer (business case; BD), the information object 12 to describe a single service (transaction; BTX) provided by the bank within the overall service, and the information object 14 to represent a transaction object (TXP) processed (e.g. moved, created, sent) by the bank within the provision of the relevant single service. Typical single services are for example a single payment transfer, a share purchase on the stock exchange, an interest statement, an address change or the preparation (printing and dispatching) of a settlement for a share purchase. A transaction object can be e.g. a value lot, which defines a set of a financial instrument (share, money, debt security) moved within a transaction. Another transaction object can be the price or transaction value of a value lot. Transaction objects can also represent tax valuations, stock exchange settlements, contract or customer data and other structured information, which are related to a service provided in the bank's customer business. These are naturally only examples of possible transaction objects, and by no means exhaustive.

Since an overall service can be made up of several single services and each single service can contain several processed objects, it must be clear that several information objects 12 can be assigned to each information object 10, and several information objects 14 to each information object 12. However, each information object 14 is always assigned to one single information object 12 only, and each information object 12 is always assigned to one single information object 10 only.

In the embodiment described here, the information objects 10, 12, 14 are described by data records, each data record representing one information object, or more precisely one version of one information object. To achieve reciprocal assignment of information objects at data record level too, an identification number can be assigned for each customer order that results in a business case, and this identification number can be inserted in each data record that represents an information object of the relevant business case.

FIG. 2 shows an example of a data record format, which can be used for the data records representing the information objects 10, 12, 14. The data records have a number of data elements, of which only part is shown in FIG. 2. In particular, each data record has as a data element held in a data field 16 a data record identifier DS-K, which can contain an indication of the type of information object involved which is represented by the relevant data record, in other words an information object 10 or an information object 12 or an information object 14. Each data record furthermore contains as a further data element an identification number GF_ID entered in a data field 18 and uniquely identifying the business case to which the relevant data record and hence the information object is assigned. The identification number GF_ID does not identify the data record, but allows logically interconnected data records to be recognised, as all data records assigned to the same business case contain this identification number GF_ID.

Each data record also contains a time-stamp field 20, in which a time stamp TS is entered. The time stamp TS represents a date and a time. The identifier DS_K and the time stamp TS together uniquely identify the data record in question. The time stamp TS allows identification of the particular version of the data record with identifier D_SK. Data records generated at different times are given different time stamps. In this way, a historical evolution of the underlying information object can be traced from the time stamps of several data records with the same identifier D_SK.

In the embodiment, each data record furthermore contains a status field 22, in which a status ST is entered. The status ST specifies a state of the information object represented by this data record. If the data model explained above is used to represent banking services, it is preferable if only such status information as is relevant to the customer is entered in the status field 22, not the information concerning the technical and internal bank processing of a business case. A status is relevant to the customer if when the corresponding state is reached, the factual or legal situation or the customer's actual options for action are changed. Thus for example, once a commercial transaction has been executed (status: executed), a customer can no longer withdraw, only cancel. The status model that defines the possible statuses should preferably be selected such that the status always reflects secured information. A status set in relation to an information object should thus mean that all process steps necessary before this status is reached are fully completed. However, the status gives no indication of whether further process steps, which must be executed after the achieved status, have already occurred.

The available statuses for the various information objects 10, 12, 14 can be at least partially different. In the case representing banking services, for example, statuses such as “instructed”, “accepted”, “rejected”, “deleted”, “withdrawn”, “unsuccessful”, “ended as instructed”, and “ended, but not as instructed” can be defined for business case information objects 10. For transaction information objects 12, for example, further statuses such as “initiated”, “executed”, “completed”, “prepared for posting”, and “posted” can be defined in addition to the above statuses. Some of the statuses listed above can also be used for information objects 14.

In addition to the data fields 16, 18, 20 and 22, each data record will also include further data fields 24, 26, . . . , in which further descriptive information (attributes) for the relevant information object can be stored.

FIG. 3 is now considered. This schematically shows a computer-implemented architecture, within which the invention can be applied. The architecture includes a component 28, which generates data records with the format shown in FIG. 2 and supplies them to a downstream component 30, in which the supplied data records are stored in a database system 32. Component 28 contains software that controls the processing of customer orders to a bank. This software is set up to map the incoming customer orders in data records according to the data model shown in FIG. 1. In particular, component 28 assigns and manages the business case identification numbers. Whenever new information objects have to be created for a business case, possibly because a further transaction must be executed within a business case, component 28 generates an appropriate number of data records and supplies these to component 30. Component 28 likewise generates new data records whenever changes arise for an information object already represented by one or more existing data records, if the nature of these changes has to be reflected in the contents of the database system 32. An example of such changes is changes to the status of information objects, as explained above. But it is not only status changes that must be reflected in the contents of the database system 32. There will also be a need to reflect other changes, especially those relevant to customers, in the contents of the database system 32. Such changes include customer name and address changes, account changes and similar. In such a case, the status of the relevant information object(s) can remain unchanged, but the change must be taken into account in the contents of database system 32.

If a data record is already stored for an information object in database system 32, then provided a relevant change has occurred in connection with this information object, component 28 generates a further data record with the same identifier DS_K as the previously existing data record, but with a different time stamp TS. The further data record thus represents a younger version of the information object, while the previously existing data record represents an older version. Changes to existing data records in the database system 32 are thereby avoided. A number of versions can thus arise during the lifetime of an information object, and it can easily be established from the time stamp which version is the current one or was the last valid one.

If changes occur in connection with an information object, it can be necessary to create a further version not only for this information object, but also for one or more other information objects, which are logically linked to the one information object in question. It is preferable here if component 28 generates versions only for those information objects for which it is essential. In connection with a customer order, a different number of versions can thus arise over its life cycle for different information objects of this customer order. FIG. 4 shows an example of a data tree for a customer order, after changes to individual information objects of the customer order have already occurred. This example of a data tree has at its head a data record 34 as the first version of a business case information object describing the customer order in general. It also contains a data record 34′, which describes another, later version of the business case information object. As discussed above, the status field of data record 34′ can contain a status other than that of data record 34, but need not. However, at least the time stamps of data records 34 and 34′ are different.

At transaction level, the data tree in FIG. 4 has one data record 36, which represents a first transaction, of which only one single version is present, and data records 38, 38′ and 38″, each representing a different version of a second transaction. Both transactions are assigned to the same business case, i.e. the data records 36, 38, 38′ and 38″ are logically linked to the data records 34 and 34′, for example by a common business case identification number.

At the transaction object level below, the data tree in FIG. 4 further contains three data records 40, 40′ and 40″, which represent three different versions of a first transaction object of the first transaction, a data record 42, which represents a single version of a second transaction object of the first transaction, and two data records 44 and 44′, which represent two different versions of a third transaction object of the first transaction. The data tree also has two data records 46 and 46′, which represent two different versions of a first transaction object of the second transaction, and a data record 48, which represents a single version of a second transaction object of the second transaction. The data records of the lowest hierarchy level are logically linked to exactly one data record of the middle hierarchy level, i.e. to exactly one transaction. To make this logical assignment recognisable, the individual transactions of component 28 can be given a unique transaction identification number—exactly as the business cases are given a unique business case identification number. This transaction identification number is entered in every data record that represents a version of the transaction in question, and in every data record that represents a version of a transaction object associated with the transaction in question. In the data format of FIG. 2, one of the further fields 24, 26, . . . could be used for entering the transaction identification number.

In the example case shown, the database system 32 comprises two databases 50 and 52, one of which, database 50, is used as the current database for saving current information, while the other database 52 serves as a historical database, to which the data records are transferred from database 50 depending on certain conditions. All the data records fed to component 30 are initially written to database 50, before they are transferred at a later time to database 52. Database 50 is considerably smaller than database 52; for example, the data volume stored in it is only about 3% of the total data volume of database system 32, while the remaining 97% is accommodated in database 52. In an alternative embodiment, instead of a single current database 50, two or more such current databases can be provided, to which database 52 is jointly assigned. That is, database 52 receives data records from each of the multiple current databases.

The data records are transferred from database 50 to database 52 by suitable software of component 30. This software checks data records that are stored in the database 50, to see whether they meet one or more predetermined conditions. If a data record meets this or these condition(s), it at least is transferred to database 52. In a preferred embodiment, dependent on such a transfer of a data record, one or more further data records may also be transferred from database 50 to database 52. In particular, the software of component 30 can be set up to check whether older versions of a data record that is to be transferred are also present in database 50. If so, the software causes all older versions of the relevant data record, i.e. of the information object thereby represented, to be transferred as well.

In one embodiment, dependent on a data record fulfilling the transfer condition(s), all those data records that represent hierarchically subordinate information objects are also transferred. In particular, this principle can be applied if the youngest version of the top information object in the hierarchy of information objects of a business case fulfils the transfer condition(s). The entire data tree of this business case is then transferred, including any older versions of the top information object (at the business case level) and all versions of the information objects at transaction level and at transaction object level. It can even be provided that the software of the component 30 checks only data records representing the information objects of the top hierarchy level, for compliance with the predetermined transfer condition(s). In such a variant, a transfer of data records which represent information objects of a hierarchy level other than the top one occurs only when an associated data record of the top hierarchy level fulfils the transfer condition(s). As a transfer condition, it can be provided that the status field 22 of the data record to be checked contains a predetermined status. In particular, it can be provided as a condition that the status field of the youngest version of the hierarchically top information object displays such a predetermined status. In the example case based on modelling banking services, the predetermined status can be one that shows that a customer order was ended, and no further transactions are to be undertaken by the bank within this customer order. In such an embodiment, the data records that model the various information objects of a customer order or business case are then held in database 50 until the customer order is ended. Afterwards, all these data records are transferred to database 52.

Alternatively or in addition to the above status condition, it can be provided that a checked data record must meet a predetermined time condition, before it is copied from the current database 50 to the historical database 52. A possible time condition concerns the time for which the relevant data record has existed in the current database 50. For data records that include the time stamp mentioned previously, this duration is easily determined, if it is assumed that the time stamp essentially reflects the time at which the relevant data record was written to database 50. A minimum predetermined interval can then be defined, for which a checked data record must have existed in database 50 since being written to it, before a transfer of this data record to database 52 is permitted. Depending on the application, this interval can be selected as wished, for example a timeframe of a day, week or month.

Another possibility for a time condition is to define a certain time as a validation criterion, to be compared with a time entry that is contained in the data records stored in the database 50. The time stamp discussed above is an example of such a time entry. However, it is also feasible that database 50 holds data records that do not have a time stamp for version identification, but do have a time field whose contents represent a time entry. An example of this is the execution day of a transaction, or the posting day of a balance position. It should be pointed out in this context that as well as data records which represent information objects of the types shown in FIG. 1, data records representing other information objects can naturally also be held in database 50: for example, account positions resulting from a transaction object of the type value lot, or account balances resulting from a large number of single account postings. With such data records it can easily be imagined that they contain one or more time entries which represent a later time than the time of generation of the data record in question. For example, a data record that represents a sales position resulting from a security transaction can contain a value date that specifies the day on which the relevant sales position should actually be entered on the customer's account. This value date is often later than the time at which the data record representing the sales position is created.

It is useful if the time used as validation criterion is specified as depending on the time at which the checking of data records occurs in the database 50. For example, the time to be used as validation criterion can be specified such that it is a predetermined interval, e.g. seven days, before the day on which the checking of data records takes place. In the checking, the time entry contained in a checked data record is then compared to see whether or not it gives a time that is before the time used as validation criterion. If this time is before the time to be used as validation criterion, i.e. if for example a time entry in a data record refers to a day that is more than seven days before the day on which the checking takes place, then the predetermined time condition counts as fulfilled in relation to this data record. Provided no further conditions are to be satisfied by the data record, it can in principle be transferred to the database 52 after this. If several time entries are included in one data record, it can be necessary that more than one of these time entries, ideally all, satisfy the predetermined time condition.

As well as a time condition, data records that represent the information objects of the types shown in FIG. 1 must preferably meet at least one other time-independent condition, and in particular the status condition discussed above. Older versions of an information object 10, 12, 14 can thus exist longer, possibly much longer than a predetermined minimum interval in the database, so long as they do not fulfil the status condition. However, as soon as a younger version of the relevant information object fulfils all transfer conditions, the older versions of the information object can also be transferred to database 52 along with this one.

As a result of the transfer of data records from database 50 to database 52 as explained above, the volume of database 50 can be kept relatively small, so that fast write accesses to database 50 for writing in new data records are possible at any time, as are read accesses by application programs 54, 56, 58, . . . schematically indicated in FIG. 3. The application programs 54, 56, 58, . . . can also access the historical data in the database 52.

It can be that data records that have already been transferred to database 52 prove afterwards to have faulty content. For example, it can be that it is later found that an earlier transaction was inadvertently or incorrectly executed. Since time-consuming modifications to existing data records should be avoided as far as possible within the terms of the invention, a table 60 indicated in FIG. 3 is set up in the database 50 in a preferred embodiment, and information about invalid data records of database 52 is stored in this table 60. Suppose for example that a data record labelled 62 in database 52 is invalid. Then the data record identifier of data record 62 (here e.g. “xyz”) is entered in table 60, and in relation to the data record identifier a marker, here e.g. “u”, is entered showing the invalidity of the data record. The table 60 can be used, for example, at a suitable other stage when there is sufficient time, to eliminate the invalid data records in database 52.

The data records that represent the various information objects 10, 12, 14 and their versions can be stored in the databases 50 and 52 in various tables, namely such that a first table or a set of first tables serves for storing data records which each represent an information object 10, a second table or a set of second tables is provided for storing data records which each represent an information object 12, and further a third table or a set of third tables is provided in which those data records are stored which each represent an information object 14.

The contents of database 50 are preferably checked at regular intervals, for example once a week, to see whether they can be transferred out. In a preferred embodiment, within the checking each data record stored in the database 50 is individually checked for whether it at least satisfies a time condition for transfer. As already mentioned, at least some of the data records can additionally be checked on at least one further transfer condition. For each data record that satisfies the time condition and if applicable the further transfer condition(s), a corresponding entry is written to a transfer list. If two or more current databases are present, the data records of each of these current databases are checked, and if applicable a corresponding entry is made in the transfer list. After all current databases have been processed, the transfer list is preferably subjected to a review. In the review, the data records that were selected and recorded in the transfer list are checked on one or more further predetermined conditions, which must be satisfied by the selected data records before they are transferred to database 52. The rules to be checked in the review can include context rules, for example, which concern the context of the data records in relation to one another. Thus an example of a review rule could be that a certain information object (entity) may be transferred out only if a logically associated other information object is also transferred at the same time. If it is found in the review that only the one information object was selected, and not the other one too at the same time, then the one information object (or the data record representing it) does not meet all conditions for the transfer and must therefore remain in the current database 50.

The procedure for this embodiment is thus as follows: Firstly, a first set of rules, which contains one or more transfer rules, is applied in order to select some of the data records held in the current database 50 and to make corresponding entries in a transfer list. In a subsequent step, the selected data records are subjected to a review using a second set of rules, this in turn containing one or more transfer rules. If it is thereby found that individual data records recorded in the transfer list may still not be transferred, their corresponding entries in the transfer list are deleted.

The data records remaining in the transfer list after the review is concluded are then transferred to database 52, and deleted in database 50. The data transfer from the current database 50 to the historical database 52 can take place at a different time from the selection and review of the data records. For example, a time can be set for transferring the data records remaining in the transfer list after review, this time being at a predetermined interval after the time at which the checking routine is begun for the selection of the data records. The data transfer from database 50 into database 52 preferably occurs during times when otherwise only light data traffic is expected, for example at nights or weekends. After the data transfer is concluded, the transfer list is deleted and is thus available again for a new selection of data records.

1. Computer-implemented method for management of electronic data, comprising the steps:
writing of one data record into a first database (50),
checking of the unchanged contents of this one data record on at least one predetermined condition and
writing of the one data record into a second database (52) depending on fulfillment of the at least one predetermined condition.

2. Method according to claim 1, characterized by the step: Deletion of the one data record in the first database (50) at a time closely related to when this data record is written to the second database (52).

3. Method according to claim 1, characterized by the step: writing of one or more further data records, which are logically linked to the one data record, to the second database (52), depending on the writing of the one data record to the second database (52).

4. Method according to claim 3, characterized by the step: deletion of each further data record in the first database (50) at a time closely related to when the relevant further data record is written to the second database (52).

5. Method according to claim 1, characterized in that the validation step can include the checking of a status field (22) of the one data record for a predetermined status.

6. Method according to claim 1, characterized in that the validation step includes the checking of whether a time (TS) specified in the one data record fufils a predetermined time condition.

7. Method according to claim 1, characterized by the step: Writing of a data record identifier for a data record (62) already written to the second database (52), and in relation to the data record identifier (“xyz”)—of an invalidity indicator (“u”) identifying this data record as invalid, to the first database (50).

8. Method according to claim 1, characterized in that the one data record represents a version of an information object (10, 12, 14) and contains a time stamp (TS) for version identification.

9. Method according to claim 8, characterized in that the time stamp (TS) contains a date and a time.

10. Method according to claim 8, characterized by the steps:
writing of several data records each representing a different version of the same information object (e.g. 34, 34′) at different times to the first database (50), and
writing of each of these data records into the second database (52) depending on fulfillment of the at least one predetermined condition by that one of these data records whose time stamp (TS) identifies the youngest version of the information object.

11. Method according to claim 8, characterized by the steps:
writing of several data records (e.g. 34, 36, 38, 40, 42, 44, 46, 48), which at least partially represent different logically interlinked information objects, into the first database (50) and—writing of each of these data records into the second database (52) dependent on the at least one predetermined condition being satisfied by one of these data records.

12. Method according to claim 11, characterized in that the information objects (10, 12, 14) are hierarchically linked to one another and the data records are written to the second database (52) dependent on a data record, which represents an information object (10) of a highest hierarchy level, fulfilling the at least one predetermined condition.

13. Computer program product, which causes the execution of the method according to claim 1 when it is processed by a computer.

14. Computer program product according to claim 13, characterized in that it is stored on a computer-readable magnetic or optical information carrier.
